(19) United States
(12) Patent Application Publication
(10) Pub. No.: US 2026/0279886 A1
(43) Pub. Date: Sep. 17, 2026

(54) ELECTROLYTE COMPOSITION

(71) Applicant: FORD GLOBAL TECHNOLOGIES, LLC, Dearborn, MI (US)

(72) Inventors: Sangil HAN, Northville, MI (US); Gunho KWAK, Novi, MI (US); Sookyung JEONG, Northville, MI (US); Keonseok OH, Novi, MI (US); Chi PAIK, Grosse Ile, MI (US)

(21) Appl. No.: 19/077,084

(22) Filed: Mar. 12, 2025

(51) Int. Cl. H01M 10/0525; H01M 10/0567; H01M 10/0568; H01M 10/0569

(52) U.S. Cl. CPC H01M 10/0525; H01M 10/0567; H01M 10/0568; H01M 10/0569; H01M 2300/0037

(57) ABSTRACT

A lithium-ion battery with an electrode assembly is presented. The electrode assembly has a current collector and a positive active material layer on the current collector. The electrode assembly also has an electrolyte including lithium hexafluorophosphate and lithium bis(fluorosulfonyl)imide in a ratio of 0.8M to 0.2M and a 7 wt. % ethoxy-phosphazene additive dissolved in a solvent mixture of ethylene carbonate and sulfolane in a 25/2 volume ratio. The electrolyte permeates a surface of the positive active material layer to suppress electrochemical oxidation of the positive active material layer during electrochemical cycling.

### TECHNICAL FIELD

The disclosure relates to electrolyte compositions for lithium-ion batteries.

### BACKGROUND

Lithium-ion batteries necessitate electrolytes that maintain high ionic conductivity and stability under elevated temperatures.

### SUMMARY

An electrode assembly includes a current collector, a positive active material layer on the current collector, and an electrolyte, including lithium hexafluorophosphate and lithium bis(fluorosulfonyl)imide in a ratio of 0.8M to 0.2M and a 7 wt. % ethoxy-phosphazene additive dissolved in a solvent of ethylene carbonate and sulfolane in a 25/2 volume ratio, permeating a surface of the positive active material layer and configured to suppress electrochemical oxidation of the positive active material layer during electrochemical cycling of the positive active material layer. The electrolyte may include 1 wt. % fluoroethylene carbonate. The electrolyte may also include 0.5 wt. % vinylene carbonate. In some configurations, the electrolyte may include 0.5 wt. % propylene sulfite. The electrolyte may further include 0.3 wt. % propylene sulfone. The electrolyte may also include 0.5 wt. % ethyl sulfate anhydride. In some configurations, the electrolyte may include 0.7 wt. % lithium difluoro(oxalato)phosphate. In other configurations, the electrolyte may include 1 wt. % fluoroethylene carbonate, 0.5 wt. % vinylene carbonate, 0.5 wt. % propylene sulfite, 0.3 wt. % propylene sulfone, 0.5 wt. % ethyl sulfate anhydride, and 0.7 wt. % lithium difluoro(oxalato)phosphate.

A battery cell includes a negative electrode, a positive electrode, and an electrolyte, including lithium hexafluorophosphate and lithium bis(fluorosulfonyl)imide in a ratio of 0.8M to 0.2M and a 7 wt. % ethoxy-phosphazene additive dissolved in a solvent of ethylene carbonate and sulfolane, saturating the negative and positive electrodes such that disassociated lithium ions from the lithium bis(fluorosulfonyl)imide are stabilized by complexation with ethoxy-phosphazene and sulfolane molecules. The electrolyte may include 1 wt. % fluoroethylene carbonate. The electrolyte may also include 0.5 wt. % vinylene carbonate. In some configurations, the electrolyte may include 0.5 wt. % propylene sulfite. The electrolyte may further include 0.3 wt. % propylene sulfone. The electrolyte may also include 0.5 wt. % ethyl sulfate anhydride. In some configurations, the electrolyte may include 0.7 wt. % lithium difluoro(oxalato)phosphate. In other configurations, the electrolyte may include 1 wt. % fluoroethylene carbonate, 0.5 wt. % vinylene carbonate, 0.5 wt. % propylene sulfite, 0.3 wt. % propylene sulfone, 0.5 wt. % ethyl sulfate anhydride, and 0.7 wt. % lithium difluoro(oxalato)phosphate.

Another battery cell includes a negative electrode, a positive electrode, and an electrolyte, including lithium hexafluorophosphate and lithium bis(fluorosulfonyl)imide and an ethoxy-phosphazene additive all dissolved in a solvent of ethylene carbonate and sulfolane, saturating the negative and positive electrodes such that lithium ions liberated from the lithium bis(fluorosulfonyl)imide are stabilized by solvation with ethoxy-phosphazene and sulfolane molecules. The ratio of lithium hexafluorophosphate to lithium bis(fluorosulfonyl)imide may be 0.8M to 0.2M. The solvent of ethylene carbonate and sulfolane may have a volume ratio of 25/2. The electrolyte may include 7 wt. % ethoxy-phosphazene, 1 wt. % fluoroethylene carbonate, 0.5 wt. % vinylene carbonate, 0.5 wt. % propylene sulfite, 0.3 wt. % propylene sulfone, 0.5 wt. % ethyl sulfate anhydride, and 0.7 wt. % lithium difluoro(oxalato)phosphate.

### BRIEF DESCRIPTION OF THE DRAWINGS

FIG. 1 is a table showing the compositions of various electrolytes;

FIG. 2 is a table comparing the physical properties and flash points of the electrolyte compositions of FIG. 1;

FIG. 3 shows ignition time test results for selected electrolyte compositions;

FIG. 4 shows the extinguishing time test results for selected electrolyte compositions;

FIGS. 5 and 6 are graphs of cycle life performance for selected electrolyte compositions;

FIG. 7 shows swelling ratios of pouch cells containing selected electrolyte compositions;

FIG. 8 shows capacity retention of battery cells containing selected electrolyte compositions; and

FIG. 9 is a schematic diagram of a battery cell, illustrating a positive electrode, a negative electrode, a separator, and a liquid electrolyte permeating the electrodes and separator.

### DETAILED DESCRIPTION

Embodiments are described herein. It is to be understood, however, that the disclosed embodiments are merely examples and other embodiments may take various and alternative forms. The figures are not necessarily to scale. Some features could be exaggerated or minimized to show details of particular components. Therefore, specific structural and functional details disclosed herein are not to be interpreted as limiting, but merely as a representative basis for teaching one skilled in the art.

Various features illustrated and described with reference to any one of the figures may be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Unless otherwise explicitly specified, all numerical values and ranges relating to quantities, measurements, percentages, weights, and similar numerical references within this document are to be understood as being preceded by the term “about.” This applies even in cases where the term “about” is not explicitly used. It is intended that all values and ranges encompass variations that may arise from standard measurement, manufacturing processes, material properties, and intended functionality of aspects of the disclosure. For example, when a composition is described as having “5 wt. % of a component,” it is to be understood as “about 5 wt. % of a component.” Furthermore, when numerical values are presented as a range, such as “100 to 200 units,” this range should be interpreted to effectively mean “about 100 to about 200 units.” Such variations are implicitly incorporated within the scope of the present disclosure.

The present disclosure relates to heat-resistant electrolyte compositions that have increased thermal stability by incorporating a specific heat-resistant material into a combination of ethoxy(pentafluoro)cyclotriphosphazene (PFPN) and sulfolane. The specific heat-resistant material is an ester derivative containing fluorine and a carbonate material containing fluorine. When combined with PFPN and sulfolane, these additives contribute to an increase in activation point and overall heat resistance of the electrolyte.

This may be due to an interaction between PFPN, sulfolane, and lithium cations as lithium-ion battery (LiB) cell temperature increases. This interaction may facilitate the desorption of fluorine-containing elements from both PFPN and the specific heat-resistant material, increasing inhibition. The desorbed fluorine elements may act as inhibitor boosters.

The increased heat resistance of the proposed electrolyte compositions is evidenced in experimental comparisons. The proposed electrolyte composition has an activation point of 95 °C or higher. Additionally, the proposed electrolyte compositions do not initiate under the same conditions, regardless of exposure duration. This behavior resembles that of ionic liquids, which are known for their heat-resistant properties. However, unlike conventional ionic liquids that require a presence exceeding 20%, leading to increased viscosity and performance trade-offs, the proposed electrolyte composition maintains an acceptable balance of viscosity and ionic conductivity.

Battery cells incorporating the proposed electrolyte compositions have equivalent cycle life performance at both room temperature and 45 °C, with increased storage performance at 60 °C. These characteristics make the proposed electrolyte compositions suitable for high-capacity LiB, particularly those used in automotive applications where high electrochemical performance may be needed.

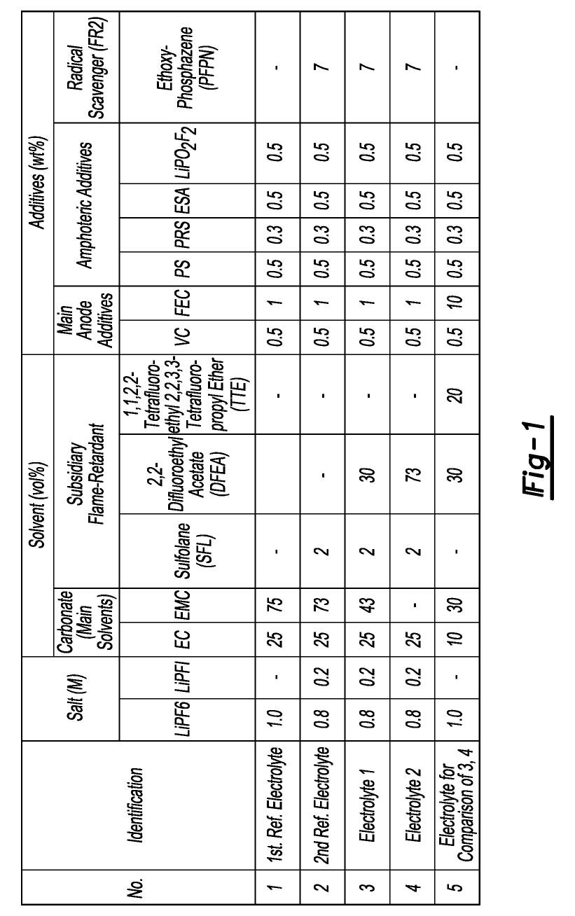

FIG. 1 is a table of compositions for various electrolytes. Each electrolyte includes a salt, a solvent system, and various additives, such as heat-resistant materials and radical scavengers.

The 1st Reference Electrolyte (Electrolyte #1) is a conventional LiB electrolyte, which contains 1.0 M lithium hexafluorophosphate (LiPF₆) as the conducting salt. The solvent utilized is 25 vol.% ethylene carbonate (EC) and 75 vol.% ethyl methyl carbonate (EMC) with 0.5 wt. % vinylene carbonate (VC), 1 wt.% fluoroethylene carbonate (FEC), and amphoteric additives, such as 0.5 wt. % polystyrene (PS), 0.3 wt. % 1,3-propene sultone (PRS), 0.5 wt. % ene sulfate (ESA), and 1 wt. % lithium difluorophosphate (LiPO₂F₂).

The 2nd Reference Electrolyte (Electrolyte #2) is also a conventional LiB electrolyte, which contains 0.8 M LiPF₆ and 0.2 M lithium bis(fluorosulfonyl)imide (LiFSI) as the salts. The solvent is 25 vol.% EC and 73 vol.% EMC, with 2 vol.% sulfolane (SFL) as a heat-resistant material. This electrolyte also includes 0.5 wt.% VC, 1 wt.% FEC, and amphoteric additives, such as 0.5 wt. % PS, 0.3 wt. % PRS, 0.5 wt. % ESA, and 0.7 to 1 wt. % of LiPO₂F₂. Additionally, it incorporates 7 wt. % ethoxy-phosphazene (PFPN) as a radical scavenger, for increased heat resistance.

The Electrolyte 1 (Electrolyte #3) contains 0.8 M LiPF₆ and 0.2 M LiFSI, with 25 vol.% EC and 43 vol.% EMC content. Heat-resistant solvents are incorporated at 2 vol.% SFL and 30 vol.% 2,2-difluoroethyl acetate (DFEA). The additive composition remains similar to Electrolyte #2, with 0.5 wt.% VC, 1 wt.% FEC, 0.5 wt. % PS, 0.3 wt. % PRS, 0.5 wt. % ESA, and 0.7 to 1 wt. % of LiPO₂F₂. The presence of PFPN is maintained at 7.0 wt.%.

The Electrolyte 2 (Electrolyte #4) also contains 0.8 M LiPF₆ and 0.2 M LiFSI with 25 vol.% EC, 73 vol.% DFEA, and 2 vol.%. The additive composition is 0.5 wt.% VC, 1 wt.% FEC, 0.5 wt. % PS, 0.3 wt. % PRS, 0.5 wt. % ESA, and 0.7 to 1 wt. % of LiPO₂F₂. The presence of PFPN is also maintained at 7.0 wt.%.

The Electrolyte for Comparison of 3 and 4 (Electrolyte #5) contains 1.0 M LiPF₆, similar to the Electrolyte #1, but reduces the carbonate solvent content to 10 vol.% EC and 30 vol.% EMC. Instead, it incorporates 30 vol.% DFEA and 20 vol.% 1,1,2,2-tetrafluoroethyl 2,2,3,3-tetrafluoropropyl ether (TTE) as heat-resistant material solvents. The additive composition also differs, with 10 wt.% VC, 1 wt.% FEC, 0.5 wt.% PS, 0.3 wt.% PRS, 0.5 wt.% ESA, and 0.7 to 1 wt.% LiPO₂F₂.

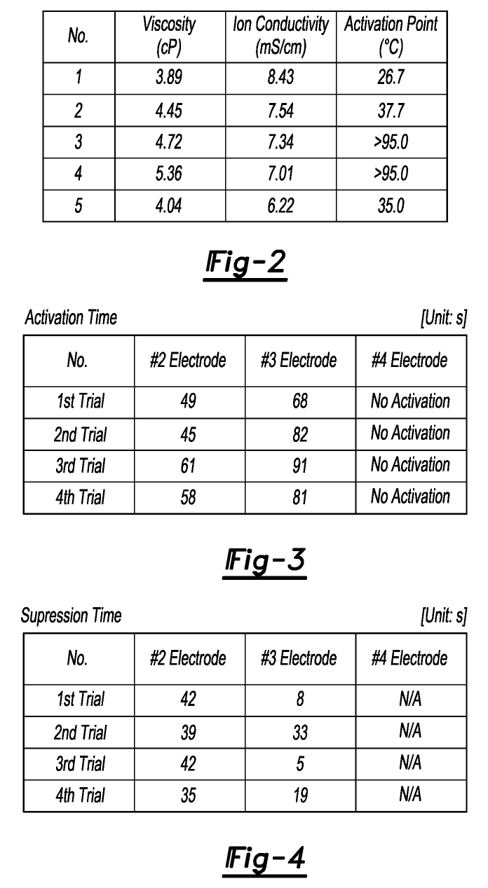

FIG. 2 is a table of physical properties and activation points of the electrolyte compositions described in FIG. 1. The table compares each formulation based on viscosity in centipose (cP), ion conductivity in milliSiemens per centimeter (mS/cm), and activation point (°C). These parameters provide insight into the balance between electrochemical performance and stability of the electrolyte compositions.

Electrolyte #1, the conventional LiB electrolyte, has the lowest viscosity at 3.89 cP and the highest ion conductivity at 8.43 mS/cm. However, it also has the lowest activation point, measured at 26.7 °C.

Electrolyte #2, the previously developed electrolyte, has a viscosity of 4.45 cP and a slight reduction in ion conductivity to 7.54 mS/cm. The activation point is 37.7 °C, suggesting an increase in heat resistance compared to Electrolyte #1.

Electrolyte #3, one of the proposed electrolyte compositions, has a viscosity of 4.72 cP and an ion conductivity of 7.34 mS/cm. The activation point exceeds 95.0 °C. This increase indicates that Electrolyte #3 has high stability under standard testing conditions.

Electrolyte #4, another one of the proposed electrolyte compositions, has the highest viscosity at 5.36 cP and an ion conductivity of 7.01 mS/cm. Similar to Electrolyte #3 it has an activation point greater than 95.0 °C. Electrolyte #5 has a viscosity of 4.04 cP and a lower ion conductivity of 6.22 mS/cm. Its activation point is measured at 35.0° C, which is significantly lower than the proposed electrolyte compositions, Electrolyte #3 and #4.

FIGS. 3 and 4 show the results of activation and suppression time tests in seconds conducted on Electrolyte #2, Electrolyte #3, and Electrolyte #4. These tests evaluate heat resistance by measuring the time required for activation and the time taken for self-suppression once activation occurs.

FIG. 3 shows an activation time for each electrolyte across four trials. Electrolyte #2 activates consistently, with activation times ranging from 45 to 61 seconds, indicating that while it exhibits some heat resistance, it remains activatable under prolonged exposure. Electrolyte #3 has increased resistance, with activation times between 68 and 91 seconds, demonstrating a delay in activation compared to Electrolyte #2. Electrolyte #4 does not activate in any trial, confirming its heat-resistant properties.

FIG. 4 measures the suppression time, or the duration for the suppression to take place after activation. Electrolyte #2 exhibits the longest suppression times, ranging from 35 to 42 seconds, suggesting that once activated, this condition persists before self-extinguishing. Electrolyte #3 shows reduced suppression times, with values between 5 and 33 seconds, indicating increased suppression. Electrolyte #4 does not activate under the test conditions, making suppression time measurements unnecessary.

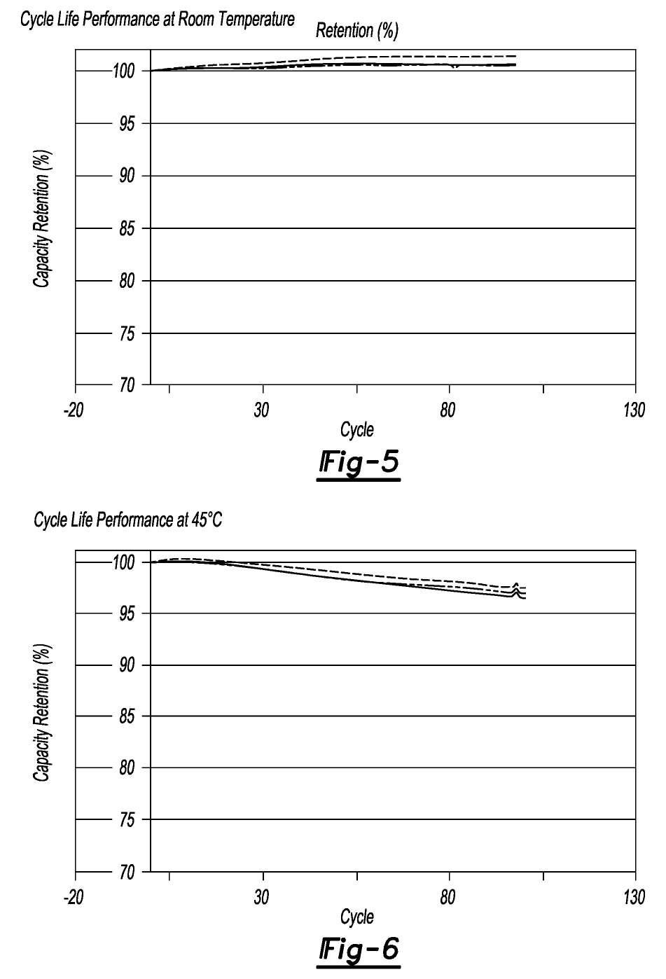

For FIGS. 5-8, the tests were conducted using 1.2 ampere-hour (Ah) nickel-rich lithium nickel cobalt manganese oxide (Ni 83%) and graphite (Gr) pouch cells incorporating Electrolyte #2, Electrolyte #3, and Electrolyte #4 under charge-discharge conditions of a 1 C-rate (C) rate. The cells were charged to a 4.2-volt (V) cut-off with a 0.02C taper current and discharged to 2.7 V.

FIGS. 5 and 6 show the cycle life performance of Electrolyte #2, Electrolyte #3, and Electrolyte #4 at room temperature in FIG. 5 and 45 °C in FIG. 6. These graphs measure capacity retention (%) over multiple charge-discharge cycles, providing insights into the long-term electrochemical stability of each electrolyte.

In FIG. 5 the data shows that all three electrolytes maintain nearly 100% capacity retention over the testing period. The curves for Electrolyte #2, Electrolyte #3, and Electrolyte #4 are closely aligned, indicating that modifications to the electrolyte composition do not negatively affect cycle stability under standard temperature conditions. This result suggests that the upgraded electrolytes, Electrolytes #3 and #4, have equivalent electrochemical performance to the reference electrolyte, Electrolyte #2, at room temperature while also having increased heat resistance.

FIG. 6 shows all three electrolytes have high capacity retention, with gradual capacity fade over the testing period. The retention curves for Electrolyte #3 and Electrolyte #4 remain nearly identical to that of Electrolyte #2, confirming that the increased heat-resistant compositions do not compromise cycle life, even at elevated temperatures.

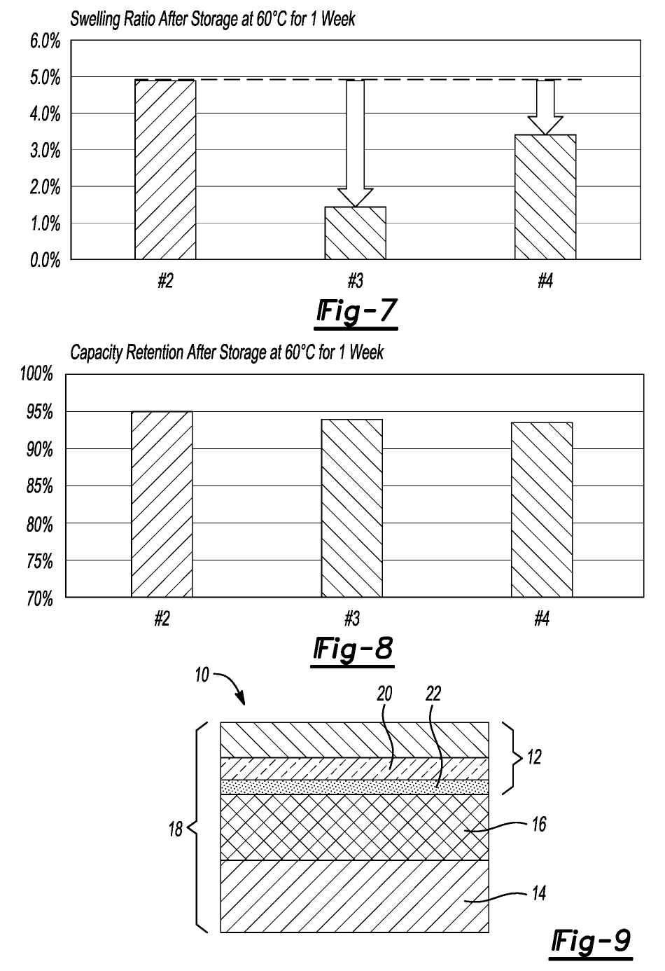

FIGS. 7 and 8 show the effects of high-temperature storage (60 °C for one week) on Electrolyte #2, Electrolyte #3, and Electrolyte #4. FIGS. 7 and 8 evaluate cell swelling behavior and capacity retention after prolonged exposure to elevated temperatures, to evaluate electrolyte stability and long-term battery performance.

FIG. 7 shows swelling ratios (%) of pouch cells after storage at 60 °C for one week. Electrolyte #2 has the highest swelling ratio, approaching 5%, indicating electrolyte decomposition and gas generation under high-temperature conditions. Electrolyte #3 shows a reduction in swelling, remaining below 1.5%, suggesting increased thermal stability and reduced side reactions. Electrolyte #4 has an intermediate swelling ratio, around 3.5%, which, while lower than Electrolyte #2, is higher than Electrolyte #3. These results indicate that Electrolyte #3 is the most resistant to gas formation and cell expansion under high-temperature storage conditions.

FIG. 8 shows capacity retention (%) after storage at 60 °C for one week. All three electrolytes maintain high capacity retention, with values above 90%, indicating that despite differences in swelling behavior, the fundamental electrochemical performance remains stable. Electrolytes #3 and #4 exhibit retention levels comparable to Electrolyte #2, demonstrating that the increased heat-resistant compositions do not negatively affect long-term charge retention under elevated temperatures.

FIG. 9 shows a battery cell 10 with a positive electrode 12, a negative electrode 14, and a separator 16 positioned between the positive electrode 12 and the negative electrode 14, with a liquid electrolyte 18 permeating the positive electrodes 12, the negative electrode 14, and the separator 16.

The liquid electrolyte 18 includes 0.8M LiPF₆ and 0.2M LiFSI as the conducting salts. The solvent system includes EC and EMC in a 25/75 volume ratio, which balances high ionic conductivity and electrochemical stability. The liquid electrolyte 18 also contains FEC at 1 wt. %, VC at 1 wt. %, and LiPO₂F₂ at 0.7 to 1 wt. %, which increase electrode passivation and cycle life. Additionally, the liquid electrolyte 18 incorporates SFL at 2 vol.% and DFEA at 30 vol.% as heat-resistant solvents, which increase thermal stability while maintaining viscosity and conductivity. In another embodiment, the liquid electrolyte 18 includes DFEA at 73 vol.% without any EMC to further increase its heat-resistant properties.

The liquid electrolyte 18 is configured to saturate the positive electrode 12, the negative electrode 14, and the separator, ensuring efficient ion transport and stable electrode interfaces. The positive electrode 12 contains a positive active material layer b, which interacts with the liquid electrolyte 18 to suppress electrochemical oxidation and reduce impedance growth. The combination of LiFSI, FEC, VC, and LiPO₂F₂ facilitates the formation of a stable interphase 22 on the positive active material layer 20, increasing long-term electrochemical stability. Additionally, the heat-resistant components of the liquid electrolyte 18 contribute to increased thermal stability without significantly affecting ionic conductivity.

The liquid electrolyte 18 also minimizes cell swelling under high-temperature storage conditions. The battery cell 10 containing this composition exhibits lower gas generation and reduced expansion when stored at 60 °C for one week, with higher mechanical stability. Furthermore, when the battery cell 10 is subjected to cycling at 45 °C, the liquid electrolyte 18 maintains high capacity retention and extended cycle life, performing comparably or better than conventional electrolytes.

The liquid electrolyte 18 may also interact with the positive active material layer 20 to alter the interphase 22 in a way that reduces impedance growth and increases electrochemical stability. The EC/EMC solvent mixture provides a balance between high ionic conductivity and electrolyte stability, contributing to the overall performance and longevity of the battery cell 10. The battery cell 10 is configured to retain its capacity over extended cycling, demonstrating increased high-temperature storage characteristics and increased cycle life performance at 45 °C, making it suitable for high-capacity LiB applications requiring durability.

While exemplary embodiments are described above, it is not intended that these embodiments describe all possible forms encompassed by the claims. The words used in the specification are words of description rather than limitation, and it is understood that various changes may be made without departing from the spirit and scope of these disclosed materials.

As previously described, the features of various embodiments may be combined to form further embodiments of the invention that may not be explicitly described or illustrated. While various embodiments could have been described as providing advantages or being preferred over other embodiments or prior art implementations with respect to one or more desired characteristics, those of ordinary skill in the art recognize that one or more features or characteristics may be compromised to achieve desired overall system attributes, which depend on the specific application and implementation. As such, embodiments described as less desirable than other embodiments or prior art implementations with respect to one or more characteristics are not outside the scope of the disclosure and may be desirable for particular applications.

What is claimed is:

1. An electrode assembly comprising:
a current collector;
a positive active material layer on the current collector; and
an electrolyte, including lithium hexafluorophosphate and lithium bis(fluorosulfonyl)imide in a ratio of 0.8M to 0.2M and a 7 wt. % ethoxy-phosphazene additive dissolved in a solvent of ethylene carbonate and sulfolane in a 25/2 volume ratio, permeating a surface of the positive active material layer and configured to suppress electrochemical oxidation of the positive active material layer during electrochemical cycling of the positive active material layer.

2. The electrode assembly of claim 1 wherein the electrolyte also includes 1 wt. % fluoroethylene carbonate.

3. The electrode assembly of claim 1 wherein the electrolyte also includes 0.5 wt. %. vinylene carbonate.

4. The electrode assembly of claim 1 wherein the electrolyte also includes 0.5 wt. % propylene sulfite.

5. The electrode assembly of claim 1 wherein the electrolyte also includes 0.3 wt. % propylene sulfone.

6. The electrode assembly of claim 1 wherein the electrolyte also includes 0.5 wt. % ethyl sulfate anhydride.

7. The electrode assembly of claim 1 wherein the electrolyte also includes 0.7 wt. % lithium difluoro(oxalato)phosphate.

8. The electrode assembly of claim 1 wherein the electrolyte also includes 1 wt. % fluoroethylene carbonate, 0.5 wt. % vinylene carbonate, 0.5 wt. % propylene sulfite, 0.3 wt. % propylene sulfone, 0.5 wt. % ethyl sulfate anhydride, and 0.7 wt. % lithium difluoro(oxalato)phosphate.

9. A battery cell comprising:
a negative electrode;
a positive electrode; and
an electrolyte, including lithium hexafluorophosphate and lithium bis(fluorosulfonyl)imide in a ratio of 0.8M to 0.2M and a 7 wt. % ethoxy-phosphazene additive dissolved in a solvent of ethylene carbonate and sulfolane, saturating the negative and positive electrodes such that disassociated lithium ions from the lithium bis(fluorosulfonyl)imide are stabilized by complexation with ethoxy-phosphazene and sulfolane molecules.

10. The battery cell of claim 9 wherein the electrolyte also includes 1 wt. % fluoroethylene carbonate.

11. The battery cell of claim 9 wherein the electrolyte also includes 0.5 wt. % vinylene carbonate.

12. The battery cell of claim 9 wherein the electrolyte also includes 0.5 wt. % propylene sulfite.

13. The battery cell of claim 9 wherein the electrolyte also includes 0.3 wt. % propylene sulfone.

14. The battery cell of claim 9 wherein the electrolyte also includes 0.5 wt. % ethyl sulfate anhydride.

15. The battery cell of claim 9 wherein the electrolyte also contains 0.7 wt. % lithium difluoro(oxalato)phosphate.

16. The battery cell of claim 9 wherein the electrolyte also includes 1 wt. % fluoroethylene carbonate, 0.5 wt. % vinylene carbonate, 0.5 wt. % propylene sulfite, 0.3 wt. % propylene sulfone, 0.5 wt. % ethyl sulfate anhydride, and 0.7 wt. % lithium difluoro(oxalato)phosphate.

17. A battery cell comprising:
a negative electrode;
a positive electrode; and
an electrolyte, including lithium hexafluorophosphate, lithium bis(fluorosulfonyl)imide, and an ethoxy-phosphazene additive dissolved in a solvent of ethylene carbonate and sulfolane, saturating the negative and positive electrodes.

18. The battery cell of claim 17 wherein a ratio of the lithium hexafluorophosphate to lithium bis(fluorosulfonyl)imide is 0.8M to 0.2M.

19. The battery cell of claim 17 wherein the solvent of ethylene carbonate and sulfolane has a volume ratio of 25/2.

20. The battery cell of claim 17 wherein the electrolyte includes 7 wt. % ethoxy-phosphazene, 1 wt. % fluoroethylene carbonate, 0.5 wt. % vinylene carbonate, 0.5 wt. % propylene sulfite, 0.3 wt. % propylene sulfone, 0.5 wt. % ethyl sulfate anhydride, and 0.7 wt. % lithium difluoro(oxalato)phosphate.
